(19) United States
(12) Patent Application Publication
(10) Pub. No.: US 2004/0247001 A1
(43) Pub. Date: Dec. 9, 2004

(54) Laser configuration with resonator internal frequency conversion

(75) Inventor: Gennadij Kusnezow, Langenhagen (DE)

Correspondence Address: CROWELL & MORING LLP, INTELLECTUAL PROPERTY GROUP, P.O. BOX 14300, WASHINGTON, DC, 20044-4300, US

(73) Assignee: LPKF Laser & Electronics AG, Garbsen (DE)

(21) Appl. No.: 10/771,512

(22) Filed: Feb. 5, 2004

(30) Foreign Application Priority Data
Feb. 7, 2003 (DE) 103 05 268.2

(51) Int. Cl. H01S 3/10

(52) U.S. Cl. 372/22; 372/100

(57) ABSTRACT

A laser configuration (1) with resonator-internal frequency conversion and having a first arm (2) which is formed by a first reflector and an output device (4) and a second arm (6) which is formed by a second reflector (8), a frequency converter (9) and an output device (4). The output device (4) is associated with a prism (5) into which the frequency-converted output beam (10) is input and can be output on an output surface (12) in the direction of the optical axis (13) after being reflected internally on a total reflection surface (11) so that the optical axis (13) and a main axis (3) of the first arm (2) correspond. The prism (5) yields output in the direction of the optical axis (13) with a low degree of effort and expense and without necessitating additional mirrors, while at the same time the effort and expense of positioning the functional optical surfaces relative to each other is avoided.

### BACKGROUND OF THE INVENTION

This invention relates to a laser configuration with resonator-internal frequency conversion, wherein a laser resonator has a first arm which is formed by a first reflector, an active medium and an output coupler, and a second arm which is formed by a second reflector, a frequency converter and the output coupler, so that a frequency-converted output beam is emitted via the output coupler, wherein the laser resonator has a length corresponding to the sum of the lengths of the first arm and the second arm, the output device is designed as an optical prism into which the frequency-converted output beam is input and can be output at an output surface in the direction of the output axis in this way, and this output axis and an optical axis of the first arm are parallel to one another.

A laser configuration of this type is known, for example, from Blumentritt et al., U.S. Pat. No. 4,933,945 (=DE 39 14 070 A1). However, it has proven to be a disadvantage here that the output axis cannot correspond to the optical axis, but instead they can only be parallel. Although an approximation of the output axis to the optical axis is possible by providing small angles, an exact correspondence is impossible. In addition, the use of the prism in German Patent 39 14 070 A1 also leads to an unwanted elliptical cross section of the emitted beam, which has proven to be a disadvantage in practical applications.

Another laser configuration with resonator-internal frequency conversion is already known from Nighan et al., U.S. Pat. No. 5,638,388 (=DE 196 80 463 T1), which describes the use of a resonator in a simple geometric configuration, a so-called V arrangement. The resonator in this case has a first arm which is formed by a highly reflective mirror and an output device. The second arm of the resonator is formed by an output device and another highly reflective mirror. A doubler crystal is positioned along the optical axis of the second arm. The laser beam generated in the resonator with the fundamental wavelength λ₁ is reflected by the output device, which has a high reflection for this wavelength, and strikes a frequency converter designed as a doubler crystal. After two passes, the output beam with the wavelength λ₂ for which the output coupler is largely transmissive and whose frequency has been doubled in the second arm is then emitted through the output coupler in the direction of the output axis without any further deflection. It has proven to be a disadvantage with this design of the resonator that the optical axis of the first arm and the output axis are at an angle to one another due to the V-shaped arrangement. This two-dimensional arrangement necessitates a considerable construction complexity and cost to bring the optical axis to the desired direction, because the output direction of the beam does not correspond to the optical axis of the laser crystal.

Yusong et al., U.S. Pat. No. 5,936,983 describes a laser arrangement having resonator-internal frequency conversion, in which the laser beam of the first arm is deflected by a mirror and then strikes the output coupler. The frequency-converted beam in the second arm is then output through the output coupler so that the output axis is parallel to the optical axis of the first arm. Again with this arrangement, the two-dimensional design of the resonator with a considerable offset of the optical axis has proven to be a disadvantage, and in addition the mirror is necessary and this increases the manufacturing cost.

Yin, U.S. Pat. No. 6,061,370 also describes output of a frequency-converted output beam by means of a prism arrangement. To create a parallelism of the frequency-converted output beam with respect to the optical axis, however, additional mirrors are required.

One might consider deflecting the frequency-converted beam directed in the direction of the output axis by means of additional reflector elements so that its axis coincides with the axis of the first arm. However, this would require additional complexity and expense, which in practice has meant that such configurations are avoided.

### SUMMARY OF THE INVENTION

The object of this invention is to provide an improved compact laser configuration.

Another object of the invention is to provide a compact laser design in which the axis of the frequency-converted output beam corresponds the optical axis of the first arm and no additional mirrors are needed in the first arm or even following the output of the output beam.

These and other objects are achieved in accordance with the present invention by providing a laser configuration having resonator-internal frequency conversion, comprising a laser resonator having a first arm formed by a first reflector, an active medium and an output device, and a second arm formed by a second reflector, a frequency converter and the output device so that a frequency-converted output beam is emitted by the output device; the laser resonator having a length equal to the sum of the lengths of the first and second arms; the output device comprising an optical prism into which the frequency-converted output beam is input and can be output on an output surface in the direction of the output axis; and the output axis and an optical axis of the first arm being parallel to each other, wherein the optical prism is designed so that the frequency-converted output beam can be output on the output surface after internal reflection on at least one total reflection surface, such that the output axis and the optical axis of the first arm correspond. Advantageous preferred embodiments of the invention are described in further detail hereinafter.

According to this invention, a laser configuration is provided in which the optical prism is designed so that the frequency-converted output beam can be output on the output surface after internal reflection on at least one total reflection surface, whereby the output axis corresponds to the optical axis of the first arm. In this way an output of the frequency-converted output beam in the direction of an axis which corresponds the optical axis of the first arm can be achieved in a simple manner without requiring additional components for deflection of the laser beam of the first arm or the frequency-converted output beam. The entry surface of the prism is coated in such a way that this entry surface forms a dispersion mirror. The laser beam of the fundamental wavelength λ₁ is essentially completely reflected while the frequency-converted output beam on the return path to the output coupler essentially enters the prism unhindered. The frequency-converted output beam is first deflected on the total reflection surface and then is output from the resonator at a diffraction angle on the output surface from the prism in the direction of the output axis, which corresponds to the optical axis of the first arm. This greatly reduces the complexity for production and adjustment of the resonator because the prism fulfills the function of the output coupler as well as the deflection of the frequency-converted output signal in the desired direction and thereby reduces the number of required components. At the same time, the overall construction of the laser becomes more compact and simpler because the relative positions of the functional surfaces of the prism are invariable and do not require any adjustment.

An especially simple modification is achieved if the prism has only one total reflection surface. This yields a simple design of the prism, which can be manufactured at a comparatively low expense at the same time. A small design size is also achieved at the same time, permitting a compact laser design. This can be implemented if the angle of incidence i of the beams on the entry surface and the entry angle on the total reflection surface in the prism i′₀ are in the following relationship to one another (it should hold that i′₀>i₀, where i₀=arcsin 1/n and n₀=refractive index of the prism material) under the condition that the entry angles on the entry surface and on the emergence surface correspond:

i+i₀=90° [1 ]

where the angle α between the entry surface and the total reflection surface of the prism satisfies the equation:

α=i′₀+arcsin(sin 1/n). [2]

For example, for a quartz prism with n=1.461 (λ=532 nm) and i=45°; i′₀=45° (i′₀>i₀=43.2°) this yields the angle 73° 57′ for α.

Another modification of the present invention which also promises success is made possible when the entry surface and the emergence surface of the optical prism enclose the Brewster angle relative to the beam axis so that the resulting losses for the p-polarized output beam can be minimized. The condition [1] for total reflection can no longer apply here, so two total reflection surfaces are required. In this case the following condition holds:

i+i′₀+i″₀=180° [3]

where i=β=arctan n is the Brewster angle and i′₀, i″₀ are corresponding total reflection angles on the first and second total reflection surfaces with i′₀>i₀; i″₀>i₀. The following equations hold for the angle α₁ between the entry surface and the first total reflection surface and for the angle α₂ between the emergence surface and the second total reflection surface:

α₁=i′₀+arctan 1/n

α₂=i″₀−arctan 1/n [4]

For the example of the quartz prism given here, where n=1.461, i′₀=45°, this yields i″₀=79° 23′, α₁=79° 23′, α₂=45°.

An especially advantageous embodiment of this invention is also realized by constructing the frequency converter for frequency multiplication, e.g., to the second, third or fourth harmonic. The particular features mentioned below must be taken into account in particular. If the laser resonator is tuned to generate a second harmonic, minimum optical losses can be achieved only when the polarization of the beam on the fundamental wavelength λ₁ takes place as s-polarization for the entry surface of the prism. In this case, the higher degree of reflection for the wavelength λ₁ and the higher transmittance of the converted wavelength λ₂ which is usually p-polarized, for the dispersion coating on the entry surface can be realized better and more effectively. In addition, the emergence surface for the p-polarized radiation can be passed through with minimal losses. For i=β, these losses are zero. In the case of generation of a third or fourth harmonic in the resonator, at which usually the polarization of the wavelength λ₁ and the wavelength λ₃ and/or λ₄ are parallel to one another, a combined delay chip with 1/1λ₁ and 1/2 λ₃, 1/1 λ₁ and 1/2 λ₄ may be arranged between the frequency converter and the prism. The polarization direction of λ₁ does not change here, but the polarization with λ₃ and/or λ₄ is reduced to 90° at the same time so that the frequency-converted beam also passes through the prism as a p-polarized beam with minimal losses.

### BRIEF DESCRIPTION OF THE DRAWINGS

The invention will be described in further detail hereinafter with reference to illustrative preferred embodiments shown in the accompanying drawing figures, in which:

FIG. 1A is a schematic diagram of a laser configuration having a prism for generating the second harmonic;

FIG. 1B is a schematic diagram of a laser configuration having a prism and a combined delay chip to generate the third harmonic (fourth harmonic);

FIG. 2 is a schematic illustration of the prism from FIG. 1 with a total reflection surface; and

FIG. 3 is a schematic illustration of another prism with two total reflection surfaces.

### DETAILED DESCRIPTION OF PREFERRED EMBODIMENTS

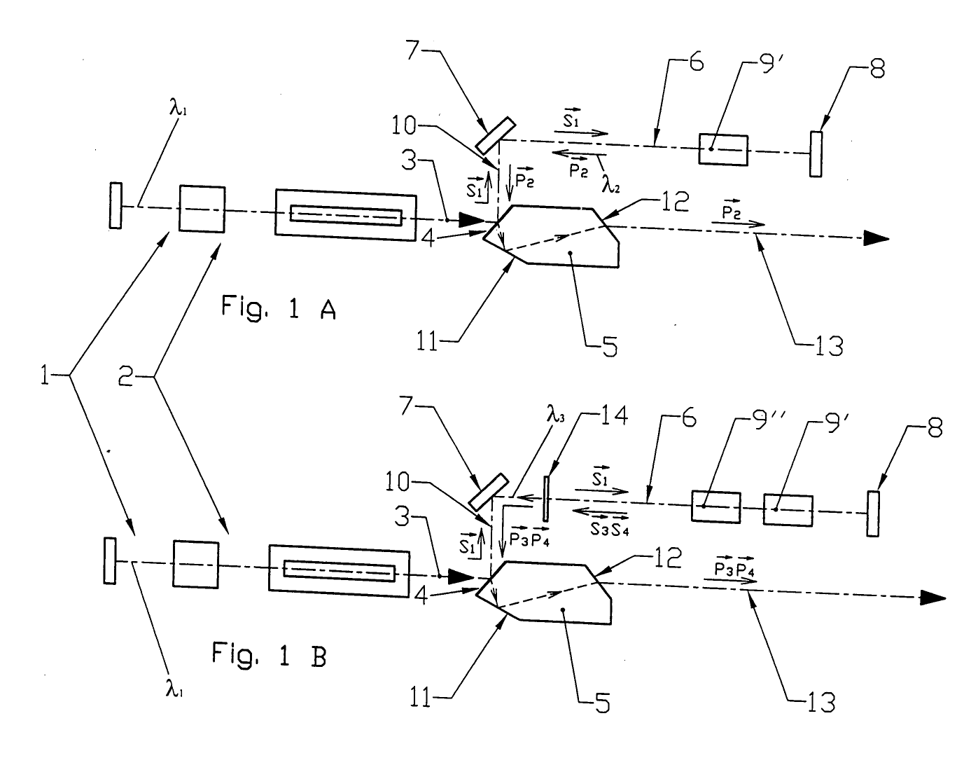

FIG. 1 shows the basic design of a laser arrangement 1 according to the invention with resonator-internal frequency conversion, with a first arm 2. The laser beam of the fundamental wavelength λ₁ and the polarization \overline{s}₁, emerges from the first arm 2 in direction 3, first striking a prism 5 which is equipped with an output device or coupler 4, whereby the laser beam is reflected and is deflected in the direction of a second arm 6 by a deflection mirror 7 onto a reflector 8. As shown in FIG. 1A the output beam 10 which is converted by a frequency converter 9′ in the opposite direction strikes the output device 4, e.g., with the wavelength λ₂ doubled and with the polarization \overline{p}₂, the coating of which (not shown) is transmissive for this wavelength λ₂.

In variant embodiment of the invention, FIG. 1B shows a modification of the laser arrangement 1 for generating the third (or fourth) harmonic with the wavelength λ₃ and/or λ₄, which is provided for this reason with a combined delay chip 14 and also with another frequency converter 9″ in addition to the frequency converter 9′. The frequency-converted output beam 10 with p-polarization \overline{p}₂, (FIG. 1A), \overline{p}₃, \overline{p}₄ (FIG. 1B) enters the prism 5, then strikes a total reflection surface 11 on which it is deflected in the direction of an output coupler surface 12. The frequency-converted output beam 10 therefore emerges from the prism 5 in the direction of an optical axis 13 which corresponds to the direction 3 of the first arm 2. Practical use is greatly simplified thereby because the number of required components is decreased and their adjustment relative to one another is eliminated.

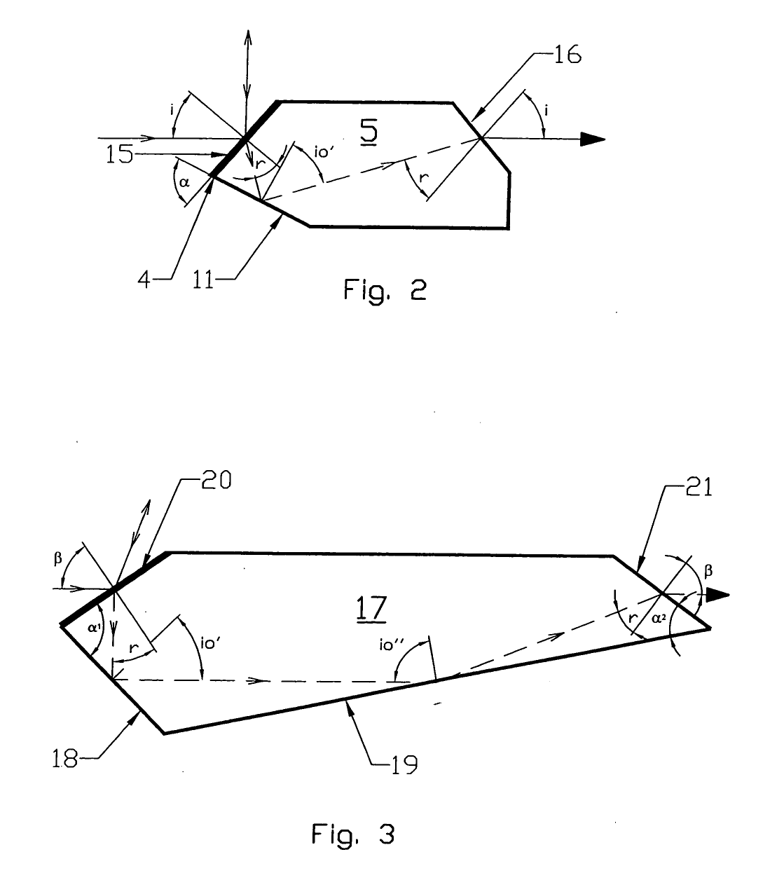

FIG. 2 shows the prism 5 depicted in FIG. 1 in an enlarged view. The drawing shows the angle of incidence i of the beams on an entry surface 15 of the output device 4. The entry angle on the total reflection surface 11 in the prism 5 is described by i′₀, where the entry angle i on the entry surface 15 and an emergence surface 16 correspond and the sum of the angles i+i₀=90°.

FIG. 3 shows another prism 17 with two total reflection surfaces 18, 19. An entry surface 20 and an emergence surface 21 of the optical prism 17 enclose the Brewster angle β relative to the beam axis. The following conditions hold for the an angle α₁ between the entry surface 20 and the first total reflection surface 18 and for an angle α₂ between the emergence surface 21 and the second total reflection surface 19:

α₁=i′₀+arctan 1/n

α₂=i″₀−arctan 1/n.

The foregoing description and examples have been set forth merely to illustrate the invention and are not intended to be limiting. Since modifications of the described embodiments incorporating the spirit and substance of the invention may occur to persons skilled in the art, the invention should be construed broadly to include all variations within the scope of the appended claims and equivalents thereof.

What is claimed is:

1. A laser configuration having resonator-internal frequency conversion, comprising a laser resonator having a first arm formed by a first reflector, an active medium and an output device, and a second arm formed by a second reflector, a frequency converter and the output device so that a frequency-converted output beam is emitted by the output device; the laser resonator having a length equal to the sum of the lengths of the first and second arms; the output device comprising an optical prism into which the frequency-converted output beam is input and can be output on an output surface in the direction of the output axis; and the output axis and an optical axis of the first arm being parallel to each other, wherein the optical prism is designed so that the frequency-converted output beam can be output on the output surface after internal reflection on at least one total reflection surface, such that the output axis and the optical axis of the first arm correspond.

2. A laser configuration according to claim 1, wherein the prism has exactly one total reflection surface, whereby for an angle α between the entry surface and the total reflection surface of the prism the relationship defined by the following equation applies:
α=i′₀+arcsin(sin i/n)
where i corresponds to the angle of incidence of the beams on the entry surface, i′₀ corresponds to the entry angle on the total reflection surface in the prism, and n₀ corresponds to the refractive index of the prism material.

3. A laser configuration according to claim 1, wherein an entry surface and an emergence surface of the optical prism enclose the Brewster angle (β) relative to the beam axis.

4. A laser configuration according to claim 1, wherein the prism has two total reflection surfaces, and for an angle α₁ between the entry surface and the first total reflection surface and for an angle α₂ between the emergence surface and the second total reflection surface the relationships defined by the following equations apply:
α₁=i′₀+arctan 1/n
α₂=i″₀−arctan 1/n
where i′₀ is the entry angle on the first total reflection surface into the prism, i″₀ is the entry angle on the second total reflection surface in the prism, and n is the refractive index of the prism material.

5. A laser configuration according to claim 1, wherein the frequency converter generates a second harmonic.

6. A laser configuration according to claim 1, wherein the frequency converter is provided with a combined delay chip for generating a third or fourth harmonic.
